(19) United States
(12) Patent Application Publication
(10) Pub. No.: US 2006/0002836 A1
(43) Pub. Date: Jan. 5, 2006

(54) Method and device for improving indoor air quality using window

(76) Inventor: Hak Guym Kim, Seoul (KR)

Correspondence Address: PENDORF & CUTLIFF, 5111 MEMORIAL HIGHWAY, TAMPA, FL, 33634-7356, US

(21) Appl. No.: 11/175,055

(22) Filed: Jul. 5, 2005

(30) Foreign Application Priority Data
Jul. 3, 2004 (KR) 10-2004-51797

(51) Int. Cl. B01D 53/74; B01J 19/08

(52) U.S. Cl. 423/210; 422/186.07; 204/176

(57) ABSTRACT

Disclosed herein is a method and a device for improving indoor air quality (IAQ) using a window. The indoor air quality is automatically controlled so that a contaminant content of air is maintained at or below an allowable limit, and the evaluated indoor air quality is numerically displayed. The method, compatible with various types of windows, comprises generating hydroxyl radicals (—OH) in an indoor space to decompose contaminants and thus remove the contaminants, measuring contents of the indoor contaminants and numerically displaying the measured contents, forcibly exhausting contaminated indoor air when the content of contaminants is at or above an allowable limit, and stopping exhaustion of air when the content is at or below the allowable limit, so that the indoor air quality is maintained at a suitable state and improved.

### BACKGROUND OF THE INVENTION

1. Field of the Invention

The present invention relates to a method and a device for improving indoor air quality (IAQ) using a window, in which the indoor air quality is automatically controlled using the window so that a contaminant content of air is maintained at or below an allowable limit, and the evaluated indoor air quality is numerically displayed.

2. Description of the Related Art

As well known to those skilled in the art, conventional windows and doors only function to open or close for the purposes of ventilation, lighting, and crime prevention. Conventionally, since indoor air is ventilated merely by manually or automatically opening or closing the window, if the window is completely closed for crime prevention during the absence of a occupant or at nighttime, it is impossible to vent or remove various generated harmful indoor substances, and contaminants existing in a room cause problems.

Of course, conventionally, an air purifier has sometimes been used to improve indoor air quality. However, this has a functional limit in its ability to improve indoor air quality. Furthermore, since it does not have a sensor for providing a numerical value, it is difficult for an occupant of the room to numerically evaluate the amount of contaminants, thus it is impossible to effectively improve and maintain the air quality. Particularly, if the air purifier is operated for a long time, amounts of anion (about 75%) and ozone (25%) increase, thus the occupant inhales an excessive amount of organic compounds.

Despite the present circumstances as described above, domestic and foreign construction companies and door industries have studied and developed construction materials used only to provide airtight and adiabatic properties after an oil crisis in the year 1972, resulting in reduced indoor air quality. Furthermore, users have neglected to pay attention to reduced air quality.

However, recently, interest in health has grown in accordance with industrial development, the cultural development, and prosperity, and health is considered the most important facet of human life.

In our current living conditions, many pollutants emitted by automobiles and industrial facilities, and harmful substances emitted by construction materials, furniture, and home appliances made of petrochemical materials threaten our health, and this issue is becoming more serious.

Particularly, an occupant stays in a closed room for about 80% of 24 hours corresponding to a day, thus continuously generating contaminated air. Hence, concentrations of indoor contaminants increase due to contaminated air. If the concentrations of indoor contaminants are not appropriately controlled, it is inevitable that the occupant will unconsciously inhale contaminated air, thus his health will be injured.

Typically, about 250 types of substances, including very fine particles, contaminate indoor air. Of them, with respect to occupantial buildings, volatile organic compounds (VOCs), such as formaldehyde (HCHO), radon, toluene, benzene, or acetone, which act as carcinogenic substances, are emitted from indoor construction materials, and nitrogen dioxide is emitted from asbestos. In views of human activities, the substances are exemplified by carbon dioxide (CO₂), emitted during the combustion of gas used to cook food in a kitchen or expired by humans, dust, cigarette smoke, the smell of feet, microorganisms (bacilli, Pseudomonas aeruginosa, O-157, or Salmonella) and volatile organic contaminants of various living articles, other offensive odors, noise, and radioactive rays. It is well known that the above-mentioned harmful substances cause skin allergies, respiratory organ diseases, or headaches, thereby negatively affecting human bodies.

The contaminants emitted from construction materials spontaneously disappear after about 1-5 years, thus their contents are lowered below the allowable limit. However, in this case, it is necessary to improve the air quality until the contaminant content is lower than the reference concentration (1000 ppm or less in terms of CO₂) suggested by the Public Health Administration Law and the Construction Law. In addition, it is impossible to completely remove carbon dioxide generated during human activities, and it is an essential substance in view of ecology and the environment.

Therefore, it is very important to set allowable limits for contaminants generated during human activities and to reduce the contaminant concentration so as to improve the air quality when they are generated in concentrations over the allowable limit, even when an occupant is absent from a room or the window is closed.

The reason is that, since most houses are not designed to spontaneously circulate indoor air, the occupants do not inhale an appropriate amount of oxygen but inhale more carbon dioxide if contaminated air is not spontaneously circulated, and, at worst, respiration difficulty or brain trouble may occur.

However, the domestic construction industry has not found a method of improving air quality in occupant buildings. In accordance with the recent growing interest in the environment among people, the “Indoor Air Quality Administration Law” was legislated so as to be in force in July, 2004, and it has been applied to public facilities, such as underground stations, underground shopping centers, terminals, libraries, and general hospitals, and new apartments. In the case of new apartments, strict regulations are in place requiring that air quality be measured and publicly announced before occupants move in, in order to manage the indoor air quality and improve a living environment.

Even though a conventional method of improving indoor air quality has an advantage in that, since a variable air volume (VAV) conditioning process is employed, energy is saved, the conventional method is problematic in that indoor air is easily contaminated because external air containing contaminants is fed, and in that it is economically inefficient because the cost of installation is high. Furthermore, in a constant air volume (CAV) conditioning process, indoor air is continuously changed to provide pleasant indoor air, but it is problematic in that high energy consumption is inevitable. Particularly, these conventional air conditioning processes are problematic in that the cost of maintenance is high.

Furthermore, in conventional goods having sterilization, deodorization, and air purifying functions to improve air quality, only sensing using a sensor is possible and the sensed air quality cannot be checked or maintained, thus occupants cannot directly monitor the air quality. Therefore, it is impossible to effectively maintain indoor air quality.

### SUMMARY OF THE INVENTION

Accordingly, the present invention has been made keeping in mind the above problems occurring in conventional improvement of air quality, and an object of the present invention is to provide a method and a device for improving indoor air quality using a window, in which the indoor air quality is automatically controlled regardless of the absence of occupants or the closed state of windows so that a contaminant content in air is maintained at or below an allowable limit, and the evaluated indoor air quality is numerically displayed. Thereby, the indoor air quality is effectively and actively controlled so as to assure a pleasant indoor environment.

Another object of the present invention is to provide a method and a device for improving indoor air quality using a window, in which, since contaminated indoor air is forcibly exhausted and the inflow of contaminated external air is blocked when the exhaustion is stopped, the air quality is efficiently improved. Furthermore, hydroxyl radicals (—OH) are generated regardless of the degree of contamination of indoor air to decompose contaminants and thus remove them, thereby significantly improving the indoor air quality.

In order to accomplish the above objects, the present invention provides a method and a device for improving indoor air quality using various types of windows. The method comprises generating hydroxyl radicals (—OH) in an indoor space to decompose contaminants and thus remove the contaminants, measuring contents of the indoor contaminants and numerically displaying the measured contents, forcibly exhausting contaminated indoor air when the content of contaminants is at or above an allowable limit, and stopping exhaustion of air when the content is at or below the allowable limit, so that the indoor air quality is maintained at a suitable state and improved.

In connection with this, measurement of the contents of contaminants using a sensor is not limited to specific materials, but it is preferable to measure the content of indoor carbon dioxide, which negatively affects humans. Furthermore, it is preferable that the amount of hydroxyl radicals be appropriately controlled depending on the indoor area using a timer.

Furthermore, indoor air is forcibly exhausted when the contaminant content in air is at or above the allowable limit, but exhaustion of air is stopped when the contaminant content in air is at or below the allowable limit. Therefore, the inflow of external air is blocked, contributing to the improvement of air quality.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart illustrating the improvement of indoor air quality according to the present invention;

FIG. 2 is a sectional view of a device for improving the indoor air quality according to the present invention;

FIG. 3 is an exploded perspective view of an exhaust unit according to the present invention;

FIGS. 4a and 4b are sectional views of an exhaust path controlling member, in which exhaust slits are opened and closed;

FIG. 5 is a front view of a contaminant content measurement indicator according to the present invention;

FIG. 6 schematically illustrates the generation of hydroxyl radicals according to the present invention;

FIG. 7 is a block diagram of a control system for improving the air quality according to the present invention; and

FIG. 8 is a flow chart illustrating the improvement of air quality using a control unit according to the present invention.

### BRIEF DESCRIPTION OF THE DRAWINGS

Hereinafter, a detailed description will be given of preferred embodiments of the present invention, referring to the accompanying drawings.

The present invention aims to provide a method and a device for improving air quality, in which the indoor air quality is automatically controlled so that an indoor carbon dioxide content is an allowable limit (1000 ppm) or less using various types of windows. Particularly, in this connection, the improvement of indoor air quality continues regardless of the absence of occupants or the open/closed state of the windows.

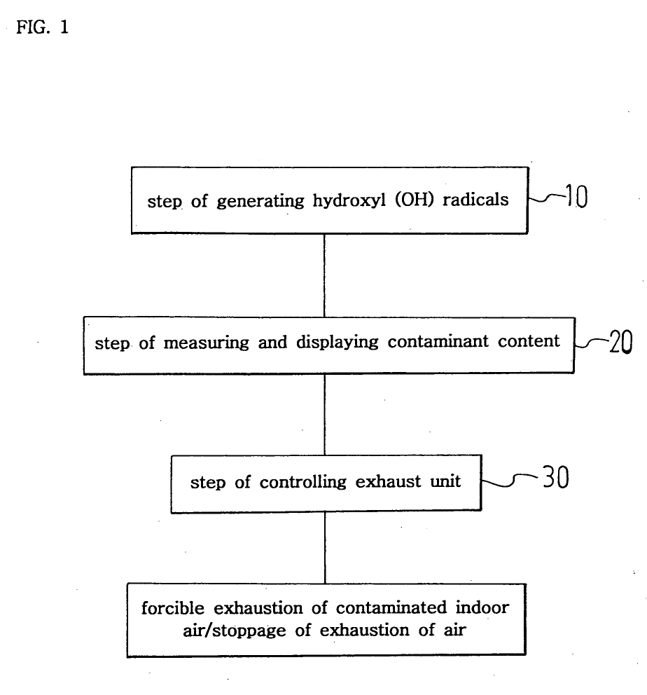

First, a brief description will be given of the improvement of indoor air quality using the window according to the present invention, with reference to FIG. 1.

In order to improve the indoor air quality using the window, first, in step 10 of generating hydroxyl radicals (—OH), indoor contaminants, for example volatile organic compounds (VOCs), such as formaldehyde, toluene, benzene, or acetone, which act as carcinogenic substances and are emitted from interior construction materials, CO₂, or ammonia, are frequently decomposed and thus removed.

Furthermore, in step 20 of measuring the amount of indoor contaminants and displaying it, the degree of contamination of indoor air is evaluated using a sensor, and is numerically displayed, thus the occupants can always see the degree of contamination of indoor air through numerical values.

Additionally, in step 30 of controlling an exhaust unit, when the contaminant content of indoor air is at or above an allowable limit (typically, 1000 ppm in terms of the indoor carbon dioxide content), operation of the exhaust unit is controlled to forcibly exhaust contaminated indoor air. When the contaminant content of indoor air is at or below the allowable limit during the forcible exhaustion, operation of the exhaust unit is stopped so that the contaminant content of indoor air is maintained at or below the allowable limit.

Meanwhile, in the present invention, measurement of the amount of contaminants using the sensor is not limited to specific materials, but, typically, it is preferable to measure the amount of indoor carbon dioxide, which is capable of being relatively easily measured. Furthermore, it is preferable that the amount of hydroxyl radicals generated be automatically controlled depending on the indoor area using a timer.

For example, a duty cycle (operation/stoppage) is appropriately controlled (for example, operation for 5 min/stoppage for 55 min, operation for 10 min/stoppage for 50 min, or operation for 15 min/stoppage for 45 min) depending on the indoor area (for example, 10 pyongs, 20 pyongs, or 30 pyongs) to appropriately decompose the indoor contaminants and thus remove them, thereby the air quality is improved.

Hence, in the present invention, it is possible to maintain the contaminant content in indoor air at or below the allowable limit through the above-mentioned steps. Since the maintenance of the contaminant content in indoor air at or below the allowable limit is automatically controlled using the sensor for measuring the amount of contaminants regardless of the absence of occupants or the closed state of the window, it is possible to effectively maintain and improve the indoor air quality.

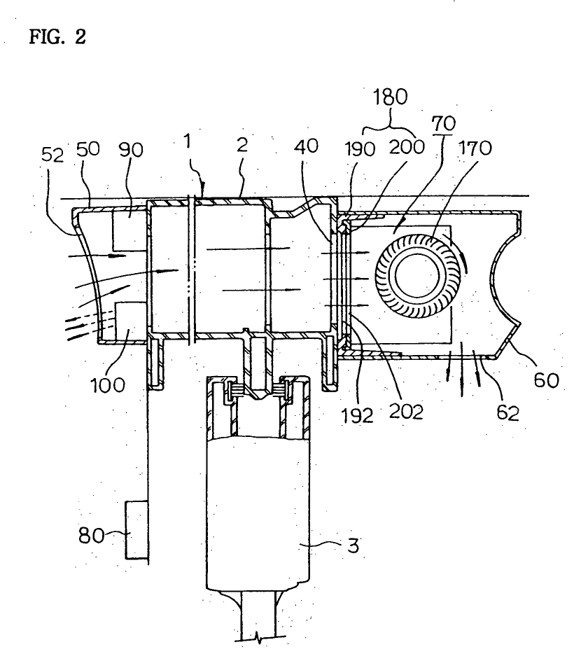

FIGS. 2 to 8 illustrate the device for improving the indoor air quality according to the present invention, and a description will be given of the device for improving the air quality referring to FIG. 2.

The device for improving the air quality according to the present invention is preferably provided at a window 1, particularly, a window frame 2 fixed to a wall, so that it is not affected by opening or closing the window 1.

An exhaust path 40 is provided at the window frame 2 to exhaust contaminated indoor air.

Additionally, a front case 50 is provided in front of the exhaust path 40, that is, in a room, and an inlet 52 having a predetermined shape, for example, the shape of a grille, is formed in the front case 50.

Furthermore, a box-shaped rear case 60 is provided at the rear of the exhaust path 40, that is, outside the room, and an outlet 62 is formed through the rear case 60.

An exhaust unit 70 is provided at the rear case 60 to forcibly exhaust contaminated indoor air through the exhaust path 40 formed through the window frame 2, or to stop the exhaustion of air.

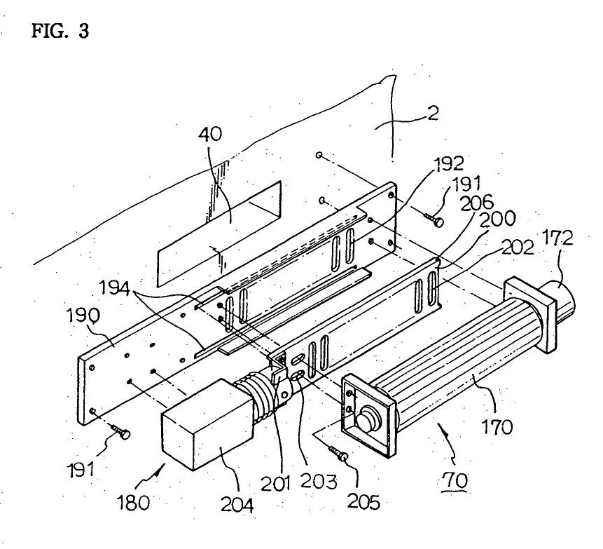

Referring to FIGS. 2 and 3, the exhaust unit 70 comprises an exhaust fan 170 which is provided with a motor 172 to forcibly exhaust contaminated indoor air through the exhaust path 40, and an exhaust path controlling member 180 for selectively opening or closing the exhaust path 40.

In connection with this, the exhaust path controlling member 180 comprises a fixed plate 190 through which a plurality of exhaust slits 192 is formed at regular intervals and which is fixed to the window frame using screws 191 outdoors so as to correspond to the exhaust path 40, and a controlling plate 200 which is movably connected to the fixed plate 190 using a bracket 201 by a solenoid 204 fixed to the fixed plate 190 in such a way that a plurality of screws 205 is threaded through openings 203, and a plurality of exhaust slits 202 is formed at regular intervals so as to simultaneously open or close the exhaust slits 192 of the fixed plate 190 and thus exhaust contaminated indoor air through the exhaust path 40 or stop the exhaustion of air.

Furthermore, it is preferable that guide grooves 194 for receiving and guiding bent portions 206 of the controlling plate 200 be further formed through the fixed plate 190 to stably move the controlling plate 200 using the solenoid 204.

Meanwhile, the exhaust fan 170 and the exhaust path controlling member 180 of the exhaust unit 70 according to the present invention may be simultaneously or sequentially controlled by a control unit 90 as will be described later.

For example, when indoor air is forcibly exhausted or the exhaustion of air is stopped by the control unit 90, the motor 172 of the exhaust fan 170 and the solenoid 204 of the exhaust path controlling member 180 are simultaneously operated to operate the exhaust fan 170 and move the controlling plate 200 with respect to the fixed plate 190, so that the exhaust path 40 is opened or closed. Alternatively, the motor 172 and the solenoid 204 are sequentially operated to open or close the exhaust path 40 using the exhaust fan 170 or movement of the controlling plate 200, so as to exhaust indoor air or stop the exhaustion of indoor air.

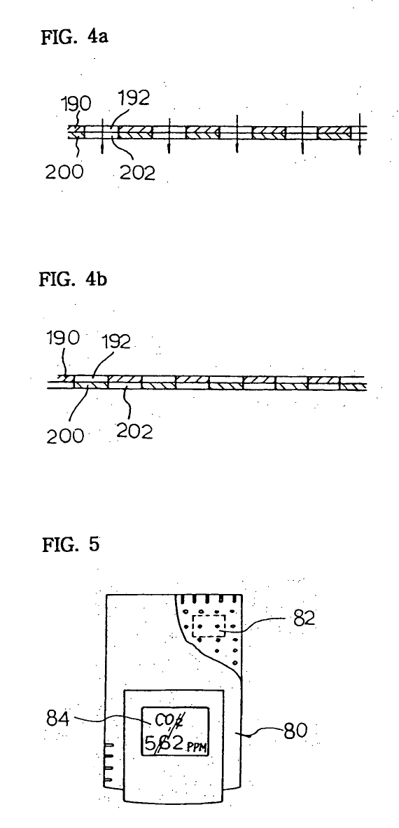

With reference to FIGS. 4a and 4b, when air is exhausted through the exhaust path 40, the controlling plate 200 is moved with respect to the fixed plate 190 by the solenoid 204 so that the exhaust slits 192, 202 are opened to forcibly exhaust air. When the exhaustion of air is stopped, the controlling plate 200 is moved so as to close the exhaust slits 192, 202, thus blocking the inflow of external air.

Referring to FIGS. 2 and 5, the device for improving indoor air quality comprises a sensor 82 for continuously measuring the amount of contaminants in indoor air and numerically providing the measured values, and a contaminant content measurement indicator 80 provided with a display window 84 for numerically displaying the measured values therethrough.

In connection with this, measurement of the amount of contaminants using the sensor of the contaminant content measurement indicator 80 is not limited to specific materials, but it is preferable that the sensor for sensing carbon dioxide be provided because the amount of indoor carbon dioxide is capable of being relatively easily measured, is impossible to control, and most significantly affects humans. Recently, the degree of contamination of indoor air has usually been evaluated based on the amount of carbon dioxide, the allowable limit of which is set to 1000 ppm.

The present invention also comprises a control unit 90 for controlling the exhaust unit 70 so as to forcibly exhaust contaminated indoor air or stop the exhaustion of air when the degree of contamination of indoor air is evaluated to be at or above the allowable limit or at or below the allowable limit using the contaminant content measurement indicator 80. It is preferable that the control unit 90 be provided in the front case 50.

Furthermore, the present invention comprises a hydroxyl radical generator 100 which frequently generates hydroxyl radicals independent of the degree of contamination of indoor air to decompose the indoor contaminants and thus remove them. The hydroxyl radical generator 100 may be provided in any position in a room, but is preferably provided in the front case 50.

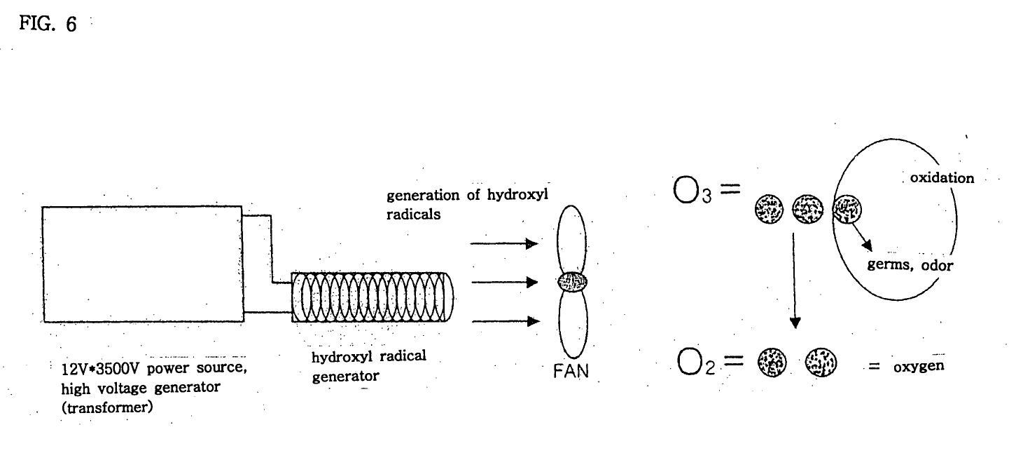

FIG. 6 illustrates the generation of hydroxyl radicals used in the present invention. Referring to this drawing, the hydroxyl radical generator 100 does not use a filter, and hydroxyl radicals are generated while O₃ is converted into O₂ using high voltage. It is reported that it has a rate that is about 100000 times as high as a typical anion generator, for example, it generates about 900000-1100000 radicals per minute.

Generally, radicals mean an unexamined substance. In an ozone radical generator, an object made of a nonferrous metal and a precious metal is used, thus the concentration of ozone is reduced. However, the reaction rate of ozone radicals with organic compounds which react slightly with ozone is at least 100000 times as high as that of ozone with the organic compounds, and the sterilizing power of ozone radicals is 10 times as high or more as that of ozone.

Furthermore, if the radicals, which are light blue gas having a peculiar smell, come into contact with organic materials or inorganics capable of easily being oxidized, nascent oxygen is instantaneously generated to provide strong sterilizing power and strongly oxidize them, and then is converted into oxygen, thereby killing disease-causing germs or various germs in air or water. Particularly, it kills viruses, amoebae, or filamentous fungi that are difficult to destroy using chlorine or other sterilizing agents, in addition to bacteria.

Furthermore, the radicals contribute to (a) the removal of volatile organic compounds (formaldehyde, benzene, toluene, acetone, etc.), (b) the destruction of infectious disease-causing germs, such as bacilli, O-157, salmonella, cholera, typhoid, or viruses, (c) the removal of offensive odors caused by carbon monoxide, sulfur dioxide gas, and ammonia gas, (d) the promotion of growth of agricultural and marine products, prevention of damage to the products from disease and harmful insects, and chemical free growth in a greenhouse, (e) the sterilization of foodstuffs, such as agricultural and marine products, and prevention of rottenness thereof, (f) the avoidance of stress, prevention of diseases, prevention of skin aging, and skin beautifying effect through bathing using ozone water, (g) the sterilization of tableware and various sanitation tableware, (h) the removal and destruction of molds and house ticks, and deodorization of bedrooms, bathrooms, living rooms, and kitchens, (i) the oxidation of bacteria and harmful substances, and supply of fresh air through conversion of ozone into oxygen, (j) the decomposition and oxidation of harmful substances, such as phenol, cyan, agricultural chemicals, iron, manganese, organics, or mercury, and (k) the improvement of BOD, COD, turbidity, chromaticity, and oxidation, and a significant increase in oxygen content.

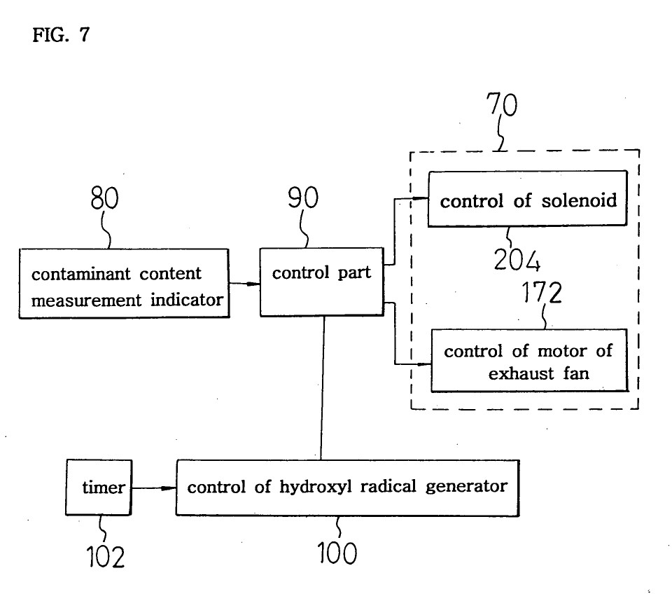

Referring to FIG. 7, it is preferable that operation (operation/stoppage) of the hydroxyl radical generator 100 for generating hydroxyl radicals (—OH) depend on the indoor area and automatically be controlled using a timer 102.

That is to say, the timer 102 is controlled depending on the indoor area (for example, 10 pyongs, 20 pyongs, or 30 pyongs) so that the operation (operation/stoppage) with respect to generation of hydroxyl radicals is adjusted (for example, operation for 5 min/stoppage for 55 min, operation for 10 min/stoppage for 50 min, or operation for 15 min/stoppage for 45 min). Thereby, hydroxyl radicals are appropriately generated depending on the indoor area.

Additionally, referring to FIG. 7, the control unit 90 is connected to the contaminant content measurement indicator 80, the motor 172 for operating the exhaust fan 170 of the exhaust unit 70, and the solenoid 204 for moving the controlling plate 200 to control them.

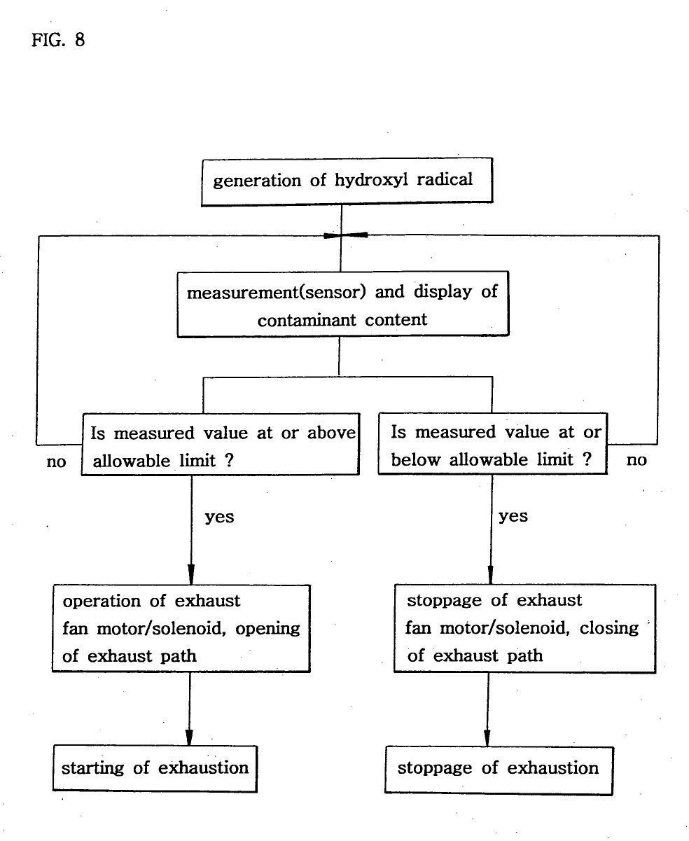

Accordingly, with reference to FIG. 8, while indoor contaminants are decomposed and thus removed using the generated hydroxyl radicals, the control unit 90 receives signals supplied from the sensor 82 of the contaminant content measurement indicator 80 to operate the exhaust fan 170 of the exhaust unit 70 and the solenoid 204 of the exhaust path controlling member 180 when a measured value is at or above the allowable limit, thereby opening the exhaust path 40 so as to forcibly exhaust contaminated indoor air.

Additionally, when the value measured using the contaminant content measurement indicator 80 is at or below the allowable limit in the course of forcibly exhausting indoor air, the operation of the exhaust fan 170 is stopped, and the solenoid 204 of the exhaust path controlling member 180 is operated to close the exhaust path 40 and thus stop the forcible exhaustion of contaminated indoor air. Through repetition of this procedure, forcible exhaustion of contaminated indoor air and stoppage of the exhaustion are repeatedly conducted.

While contaminated indoor air is forcibly exhausted or the exhaustion is stopped, the amount of indoor contaminants measured using the sensor 82 is continuously and numerically displayed through the display window 84 of the contaminant content measurement indicator 80.

Therefore, in the present invention, it is possible to improve the indoor air quality using the window 1. Furthermore, since the contaminant content of the indoor air is maintained at or below the allowable limit using the sensor 82 of the contaminant content measurement indicator 80 without opening the window 1 regardless of the absence of occupants or the closed state of the window, it is possible to create a pleasant indoor environment.

As well, since contaminated indoor air is forcibly exhausted, it is possible to prevent problems caused by the inflow of external air during the improvement of indoor air quality.

Meanwhile, in the present invention, since contaminated indoor air is forcibly exhausted, a shortage of indoor oxygen due to excessive exhaustion of air may seem to be a problem. However, since air continuously enters through fine gaps of the window frames or due to the entrance and exit of the occupants, the shortage of indoor oxygen due to the exhaustion does not occur, which was confirmed by test results.

Additionally, in the present invention, the sensor 82 for measuring the amount of contaminants is designed so that only the module needs be replaced every 15 years, and an electric charge required to operate the system is confirmed to be about 500 won per month from the test results. Thus, the cost of maintenance of the system according to the present invention is very low, which minimizes an economic burden.

Furthermore, in the present invention, since contaminated indoor air is forcibly exhausted using the exhaust unit 70 and indoor harmful substances are readily decomposed and thus removed using hydroxyl radicals, the air quality is still further improved, and physical and mental benefits are provided to the occupants due to the removal of the harmful substances even if they stay in a room for a long time.

As described above, in the present invention, it is unnecessary to open or close individual windows because indoor air quality is improved using the windows, and it is possible to maintain the contaminant content in indoor air at or below an allowable limit regardless of the absence of occupants or the open/closed state of the window because the indoor air quality is automatically maintained using a sensor and numerically displayed. Furthermore, contaminants are continuously decomposed and thus removed using hydroxyl radicals (—OH) to effectively and actively maintain and improve the indoor air quality. Thereby, negative effects caused by indoor contaminants can be overcome all at once.

Additionally, in the present invention, since contaminated indoor air is forcibly exhausted to improve the indoor air quality, it is possible to reliably prevent the reduction of indoor air quality due to the inflow of external air.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, if necessary, hydroxyl radicals may be generated for a few minutes using a control unit after contaminated indoor air has been exhausted at or below an allowable limit.

What is claimed is:

1. A method of improving indoor air quality using various types of windows, comprising:
generating hydroxyl radicals (—OH) in an indoor space to decompose contaminants and thus remove the contaminants;
measuring contents of the indoor contaminants and numerically displaying the measured contents; and
forcibly exhausting contaminated indoor air when the content of contaminants is at or above an allowable limit, and stopping exhaustion of air when the content is at or below the allowable limit, so that the indoor air quality is maintained at a suitable state and improved.

2. The method as set forth in claim 1, wherein the generation of the hydroxyl radicals (—OH) is repeatedly and automatically controlled to be turned on and off by a timer, depending on a volume of the indoor space regardless of the degree of contamination of the indoor air.

3. The method as set forth in claim 1, wherein the measurement of contents of the indoor contaminants is achieved by measuring a content of carbon dioxide (CO₂), among the contaminants of indoor air.

4. A device for improving indoor air quality using various types of windows, comprising:
an exhaust path provided at a window frame to exhaust air;
a front case, which is provided in front of the exhaust path in a room and through which an inlet is formed;
a rear case, which is provided at the rear of the exhaust path outside the room and through which an outlet is formed;
an exhaust unit, which is provided in the rear case to forcibly exhaust the contaminated indoor air through the exhaust path or to stop exhaustion of the air;
a contaminant content measurement indicator for continuously measuring a content of contaminants in the indoor air using a sensor and for numerically displaying measured values therethrough;
a control unit for controlling the exhaust unit so as to forcibly exhaust the contaminated indoor air or stop exhaustion of the air, respectively, when the degree of contamination of the indoor air is evaluated to be at or above the allowable limit or at or below the allowable limit using the contaminant content measurement indicator; and
a hydroxyl radical generator which readily generates hydroxyl radicals (—OH) independently of the degree of contamination of the indoor air to decompose the indoor contaminants and thus remove the contaminants.

5. The device as set forth in claim 4, wherein the exhaust unit comprises an exhaust fan provided with a motor, and an exhaust path controlling member for opening or closing the exhaust path.

6. The device as set forth in claim 5, wherein the exhaust path controlling member comprises:
a fixed plate through which a plurality of first exhaust slits is formed at regular intervals and which is fixed to a window frame outdoors so as to correspond to the exhaust path; and
a controlling plate which is movably connected to the fixed plate by a solenoid fixed to the fixed plate, so that a plurality of second exhaust slits is formed at regular intervals to simultaneously open or close the first exhaust slits of the fixed plate and thus exhaust contaminated indoor air through the exhaust path or stop exhaustion of air.

7. The device as set forth in claim 6, wherein the motor of the exhaust fan and the solenoid of the exhaust path controlling member are simultaneously or sequentially controlled by the control unit.

8. The device as set forth in claim 6, wherein guide grooves for receiving and guiding bent portions of the controlling plate are further formed on the fixed plate, and openings are further formed through the controlling plate so that the controlling plate is stably moved while the controlling plate is connected to the fixed plate using screws threaded therethrough.

9. The device as set forth in claim 4, wherein the sensor for measuring the content of the contaminants is a sensor for measuring carbon dioxide content of the indoor air.

10. The device as set forth in claim 4, wherein the generation of the hydroxyl radicals (—OH) by the hydroxyl radical generator is turned on or off depending on a volume of the indoor space.

11. The device as set forth in claim 4, wherein the hydroxyl radical generator is automatically controlled using a timer.
